(19) United States
(12) Patent Application Publication
(10) Pub. No.: US 2024/0119089 A1
(43) Pub. Date: Apr. 11, 2024

(54) CASCADED VIDEO ANALYTICS FOR EDGE COMPUTING

(71) Applicant: Microsoft Technology Licensing, LLC, Redmond, WA (US)

(72) Inventors: Ganesh ANANTHANARAYANAN, Seattle, WA (US); Yuanchao SHU, Bellevue, WA (US); Shadi NOGHABI, Seattle, WA (US); Paramvir BAHL, Bellevue, WA (US); Landon COX, Seattle, WA (US); Alexander CROWN, Bellevue, WA (US)

(73) Assignee: Microsoft Technology Licensing, LLC, Redmond, WA (US)

(21) Appl. No.: 18/537,291

(22) Filed: Dec. 12, 2023

Related U.S. Application Data
(63) Continuation of application No. 16/431,305, filed on Jun. 4, 2019.

(51) Int. Cl. G06F 16/71; G06F 16/738; G06F 16/783; G06V 20/40

(52) U.S. Cl. CPC G06F 16/71; G06F 16/738; G06F 16/7837; G06V 20/40

(57) ABSTRACT

This document relates to performing live video stream analytics on edge devices. One example determines resources available to the system, and a video analytics configuration is selected that distributes work between edge devices and cloud devices in a cascading manner, where edge device processing is prioritized over cloud processing in order to conserve resources. This example can dynamically modify the allocation of processing depending on changing conditions, such as network availability.

### CROSS-REFERENCE TO RELATED APPLICATIONS

This application is a continuation of U.S. patent application Ser. No. 16/431,305, filed on Jun. 4, 2019, the disclosure of which is hereby incorporated by reference in its entirety.

### BACKGROUND

Throughout the world, the deployment of cameras has increased exponentially, in part due to the rapid increase in “smart” devices throughout households. In particular, easy availability of inexpensive Internet of Things (IoT) cameras have resulted in a dramatic increase in camera usage in numerous settings, such as homes, workplaces, factories, restaurants, and streets of cities and towns. Analyzing live video streams from these cameras is of considerable importance to many organizations. For example, traffic departments may analyze video feeds from intersection cameras for traffic control, and police departments may analyze city-wide cameras for surveillance. This is typically performed by utilizing uplink bandwidth between the camera and cloud services to provide the video content for processing. However, with the increase resolution associated with such cameras, often such bandwidth is insufficient to support uploading all of the camera feeds to the cloud for analytics. Moreover, processing requirements for the cloud can become expensive, or network unavailability can severely hinder the usefulness of such cameras.

As such, while the use of cloud services can provide the ability to analyze live video streams, the processing of all video content at the cloud introduces a high computational cost and network cost to support all of the data coming to the cloud, and there remain difficulties in performing video analytics in an efficient and accurate manner.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The description generally relates to techniques for performing video analytics. One example includes a system that includes a processor and a storage memory storing computer-readable instructions, which when executed by the processor, cause the processor to receive a video query regarding a live video stream determine resources available to the system and a defined threshold confidence value associated with the video query, select a configuration for processing the video query based at least on the determined resources allocate processing between one or more cameras and one or more edge devices according to the selected configuration, and adjust the selected configuration to include processing among one or more cloud devices when processing results from the one or more cameras and the one or more edge devices do not meet the defined threshold confidence value.

Another example includes a method or technique that can be performed on a computing device. The method can include allocating processing of input data between one or more edge devices and one or more cloud devices, the one or more edge devices using an edge processing model, and the one or more cloud devices using a cloud processing model different from the edge processing model, determining a current network capability between the one or more edge devices and one or more cloud devices, and shifting processing load of the input data to increase processing by the one or more local edge devices using a moderate computationally-intensive algorithm upon determining that the current network capability between the one or more edge devices and the one or more cloud devices is unavailable.

Another example includes an alternative method or technique that can be performed on a computing device. The method can include receiving input video data from one or more cameras, accessing a database of a plurality of video processing configurations, evaluating the plurality of video processing configurations against resource availability across local devices and cloud devices, and selecting a configuration of processing models that assigns processing to the one or more cameras, one or more edge devices, and one or more cloud devices.

The above listed examples are intended to provide a quick reference to aid the reader and are not intended to define the scope of the concepts described herein.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIG. 1 illustrates an example system that is consistent with some implementations of the present concepts.

FIGS. 2A-2D illustrate an example scenario that is consistent with some implementations of the present concepts.

FIGS. 3 and 4 illustrate example processes that are consistent with some implementations of the present concepts

FIG. 5 illustrates an example method or technique that is consistent with some implementations of the present concepts.

FIG. 6 illustrates an example system that is consistent with some implementations of the present concepts.

### DETAILED DESCRIPTION

### Overview

The emerging era of IoT devices throughout the world has brought on new challenges to distributed processing. With the rapid proliferation of IoT devices and the massive increase in amounts of data the devices can generate, the total amount of data that needs to be processed from these devices can potentially overburden available network bandwidth and/or cloud processing capabilities.

As an alternative to the centralized, cloud-based computing paradigm for IoT video analytics, query processing can instead be performed locally at the edge, either by the IoT devices or at edge processing units, such as a server associated with a cluster of IoT devices. In this manner, overall processing costs can be reduced by efficiently managing processing between both edge devices and cloud devices. By managing video queries appropriately and enabling processing on the edge, a video analytics system can lower computational resource utilization and produce results with higher accuracy, while also avoiding potential downfalls of a cloud-only system, such as network unavailability or downtime.

As used herein, reference to an “edge” device or processing unit can mean any device or collection of devices capable of independent processing in a network that is located between a source IoT device and a centralized cloud processing system. Furthermore, as used herein, reference to computational resource utilization may also be referred to as a computational “cost” and certain processing models may have less or greater cost than others. For example, a certain processing model may be more “expensive” than another processing model, meaning that the processing model uses a greater amount of computational resources than some other processing model.

Certain video analytics processing can make static decisions regarding allocation of processing of video frames. These decisions can often be conservative on resource demands, but can also result in low accuracies while leaving resources underutilized. At the same time, running all queries at the highest accuracy can be infeasible due to a lack of computational power to run all of the processing at the edge, or a lack of bandwidth to push all video streams to the cloud. Stream processing systems can also employ fair sharing among queries, but fair sharing can also result in underutilized resources because decisions are agnostic to the resource-accuracy relationships of queries. As such, the disclosed implementations are directed to a dynamic video analytics system that can determine allocation of processing resources between edge devices and cloud devices dynamically, based at least on changing configurations and system conditions.

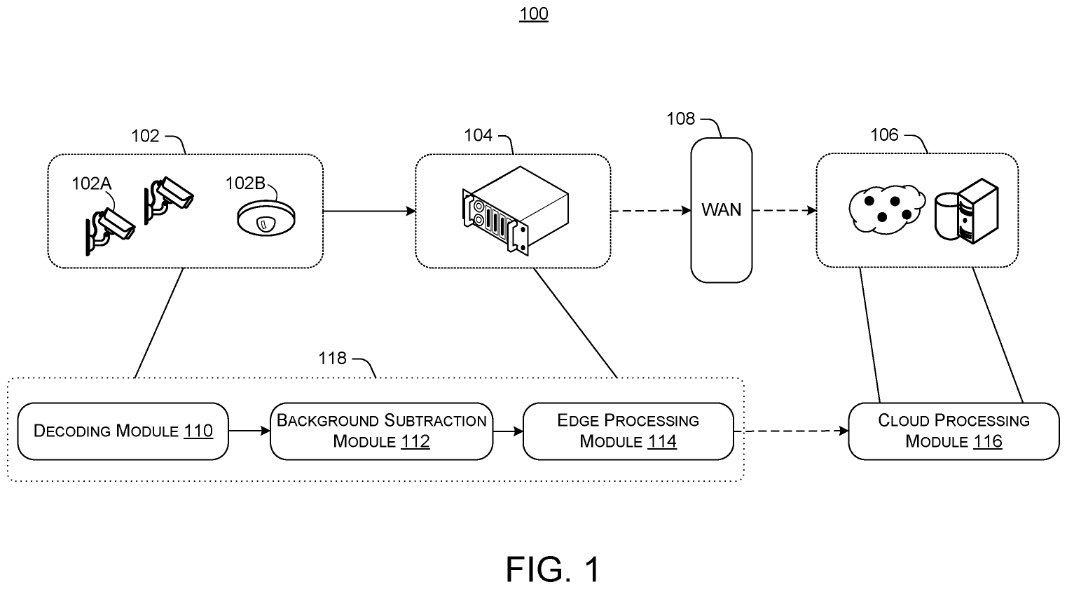

FIG. 1 illustrates an example dynamic video analytics system 100 providing a video analytics pipeline that can be used according to one implementation. System 100 may include one or more smart cameras 102, which may be any type of camera that can be used to record live video and stream the video to another location, such as pan-tilt-zoom cameras 102A and/or ceiling-mounted 360 degree dome security camera 102B. Smart cameras 102 may be communicatively coupled to an edge device 104 via either a wired or wireless connection, whereby streaming video can be provided from smart cameras 102 to edge device 104. Smart cameras 102 and edge device 104 may be commonly located within a location or environment, such as an office building, home, factory, or other such facility. For example, smart cameras 102 may be installed within various rooms of an office, and edge device 104 may be a local server in charge of managing data originating from smart cameras 102 located within the office. Alternatively, smart cameras 102 and edge device 104 may be located outside, such as traffic cameras at an intersection, with a processing unit serving as edge device 104 placed close to the camera. Edge device 104 may store data associated with smart cameras 102 in one or more storage devices and/or databases associated with edge device 104, and may coordinate transmission of data to the cloud for processing.

Smart cameras 102 may be configurable to control settings associated with the cameras, such as frame resolution and frame rate, thereby affecting the resulting bitrate (and corresponding size requirements) of the video stream. These settings can tremendously influence bandwidth requirements, as the network bandwidth required to support a single camera can range from hundreds of kilobits per second for low resolution wireless cameras, to a few megabits per second for high-resolution video. Furthermore, the settings associated with the cameras can also directly influence the computing capacity required to process any streamed video, such as whether a video stream can be processed by a simple CPU associated with an individual camera, or whether a dedicated GPU associated with a different device, such as edge device 104, may be utilized to assist with processing of the video stream.

While used for example purposes, it is to be appreciated that smart cameras are only used as examples, and smart cameras 102 can be any IoT device that can react to or record environmental data for processing, such as temperature sensors, virtual assistants, or other such IoT devices. The data processing techniques described herein can therefore to be for any type of recorded data, and is described with reference to video stream data for example purposes.

It is to be further appreciated that there may be more than one edge device 104, and that various clusters of smart cameras 102 and one or more edge device 104 may be assigned to various sections of an office or other such facility. For example, each floor of an office building may have a plurality of smart cameras 102 installed in various rooms of the office building. The data associated with the smart cameras installed on that particular floor may be associated with a dedicated edge device that is also associated with that particular floor.

Edge device 104 may also be connected to a cloud device 106 via a wide area network 108 in order to utilize computing resources associated with the cloud, such as Microsoft Azure®. Such computing resources associated with cloud device 106 can be used to provide heavy processing capabilities that may be beyond the processing capabilities of smart cameras 102 or edge device 104. Each of smart cameras 102, edge device 104, and cloud device 106 may differ in the type of hardware available. For example, certain devices (including the cameras) may include dedicated GPUs for enabling processing of data, in addition to existing CPUs, while in other instances, dedicated GPUs may be available only at edge device 104 and cloud device 106.

As depicted in FIG. 1, a video analytics pipeline can be defined for a particular video stream processing query, where the pipeline can be used to dynamically manage processing of incoming video streams by determining an appropriate allocation of processing resources among smart cameras 102, edge device 104, and cloud device 106. For example, a video analytics query related to detecting the presence of vehicles within video frames may be desired by a fast food restaurant. In this instance, smart cameras 102 may be placed in positions such that live steaming video from the cameras can be used to determine whether a vehicle has entered the vision field of the cameras.

A video analytics query can therefore involve a pipeline of computer vision processing components that can perform processing on the video stream. For example, in determining the presence of a vehicle in a video stream, a query can include a decoding component that converts video to frames, followed by a detector component that identifies any potential objects in each frame, and an associator component that matches objects across frames, thereby tracking them over time. Video query components may have many different implementation choices that provide the same abstraction, though at different amounts of processing expense.

For purposes of managing resources available to the system and avoid overburdening the available computational resources and/or network bandwidth, the video analytics pipeline can be used to determine what processing should occur on certain aspects of the system. For example, certain processing that may be low in resource consumption can be performed on smart cameras 102 or edge device 104, but the allocation of work to these devices can be difficult due to the low computational power associated with the devices. Furthermore, the bandwidth available for transmission of data between the devices can also be limited.

As such, a cascading model of operations can be defined, where work can be allocated to various components of the system for processing. In some instances, every component of the pipeline does not have to be invoked for each frame received from the cameras, which can assist with conserving computational resources and bandwidth. Furthermore, the video analytics pipeline can favor the use of CPU-based processing before relying on computationally-intensive GPU-based processing, and can further rely on local data processing results rather than relying on cloud processing, saving processing resources and network resources.

This cascading model can rely on various parameters, such as network availability, processing capabilities of components in the pipeline, configurations of the video stream, and/or threshold confidence values associated with each of the processing steps depending on the query subject. For example, in certain instances, a user issuing a query for video processing may only be interested in a simple analysis of a video stream to detect any and all possible movement within the video stream. Because we are interested in detecting any possible movement, there does not need to be a high level of confidence in the data processing results, and as such, simple CPU-based processing can be performed on individual video frames, rather than requiring GPU-based processing or some other computationally-intensive processing. While the GPU-based processing may yield higher confidence results, it would be overkill for the intended query and would only waste valuable processing resources.

For example, as depicted in FIG. 1, a video analytics pipeline associated with tracking a vehicle may involve various processing components, such as decoding module 110, background subtraction module 112, edge processing module 114, and cloud processing module 116. These modules can be invoked in a cascading manner where each step is potentially associated with increasing computational cost to the overall system. For example, the pipeline may rely on results from edge processing module 114 to the extent possible, and may only invoke cloud processing module 116 when the processing results from the edge processing module 114 do not meet a defined threshold confidence value, as the pipeline attempts to minimize the overburdening of resources available to the system. In such an instance, edge processing module 114 may utilize a processing model that is different from the processing model that is utilized by cloud processing module 116, as the processing model that is utilized by cloud processing module 116 may be a more computationally expensive model.

Decoding module 110 may receive as input a live video stream and extract frame data from the live video stream to produce extracted video frames, which can be passed to background subtraction module 112. Background subtraction module 112 can perform background subtraction on the frame data, which is a low-cost process that can be run on the devices without requiring a large amount of computational resources. The background subtraction can detect changes in each frame, and if a change in a region of interest of the frame is detected, background subtraction module 112 can pass the frame to edge processing module 114 for further processing, such as to determine with greater specificity what the change in the frame may represent.

In certain instances, the processing of the frame by background subtraction module 112 is used as a simple trigger to determine whether additional processing should be performed up the pipeline. Therefore, background subtraction module 114, upon detecting movement based on background subtraction, can pass the frame data received from decoding module 110 to the next module in the pipeline, but in certain instances, the results of the background subtraction process can also be provided.

It is to be appreciated that in certain instances, there may be no need to pass information on to edge processing module 114. For example, if a given video analytics query is only concerned with detecting any possible movement in frames, the threshold confidence value can be set low, and the results from background subtraction module 112 may be sufficient to achieve these goals, thereby obviating the need to involve any additional processing up the pipeline.

Furthermore, in certain instances, a key area of a video stream can be defined. For example, in a video stream of a highway road near a service station, a user may only be interested in determining movement in a service station offramp from the highway, as there is interest in determining whether vehicles are approaching the service station. As such, certain areas of the video stream can be designated in advance, and simple background subtraction can be used to determine whether there could potentially be movement in this designated area, while being able to ignore the majority of movement that would be associated with the highway. Moreover, when movement is detected in this area, alerts can be provided to allow a user to know that a potential vehicle is heading toward the service station.

Edge processing module 114 can receiving frame data from background subtraction module 112 and may invoke a processing model on the frame data. The processing model used by edge processing module 114 can be considered a “lightweight” model, in that the model may have fewer parameters, less layers, and overall does not require a high computational cost when compared to a “heavy” model. In certain instances, the lightweight model may have a different architecture than a heavy model that performs the same functionality. Therefore, in general, a lightweight model can be considered any model that is computationally-cheaper than a heavy model, while performing similar or the same functionality as the heavy model. For example, the processing model utilized by edge processing module 114 can be a computationally-cheaper (i.e., lightweight) DNN model. While background subtraction can require fewer computational resources than running the lightweight DNN model, background subtraction can also be less accurate because it can miss stationary objects.

As such, edge processing module 114 may invoke a lightweight DNN model, such as tiny Yolo, to indeed confirm that an object of interest pertaining to the query (e.g., a vehicle) is located within the frame. If edge processing module 114 does not determine a result within a threshold confidence value, then the pipeline can invoke cloud processing module 116 on cloud device 106. Cloud processing module 116 can invoke a “heavy” model (i.e., a computationally-expensive model which may be more expensive than the lightweight model), such as full YoloV3, which can provide a greater amount of accuracy in object detection.

In this example, the various processing performed by decoding module 110, background subtraction module 112, and edge processing module 114 can be viewed as local processing 118, as the processing can all be performed locally distributed between smart cameras 102 or edge device 104. Moreover, in certain instances, the processing may be performed solely by smart cameras 102, or solely by edge device 104, depending on potential unavailability of any of the devices. As such, a lightweight DNN model could potentially be run on smart cameras 102, in the event that edge device 104 is unavailable. If the results of local processing 118 do not meet the threshold confidence value, then data can be sent to cloud device 106 for processing through, for example, WAN 108, but the pipeline may seek to rely on local processing results as much as possible.

Furthermore, it is to be appreciated that multiple lightweight processing models may be utilized by edge processing module 114, and multiple heavy processing models may be utilized by cloud processing module 116. For example, rather than a single lightweight DNN model, there may be a plurality of lightweight DNN models that are of increasing computational cost, and while a first lightweight DNN model may not achieve the desired threshold confidence value, a second lightweight DNN model may perform sufficiently better to achieve the desired threshold confidence value without having to resort to invoking cloud processing module 116.

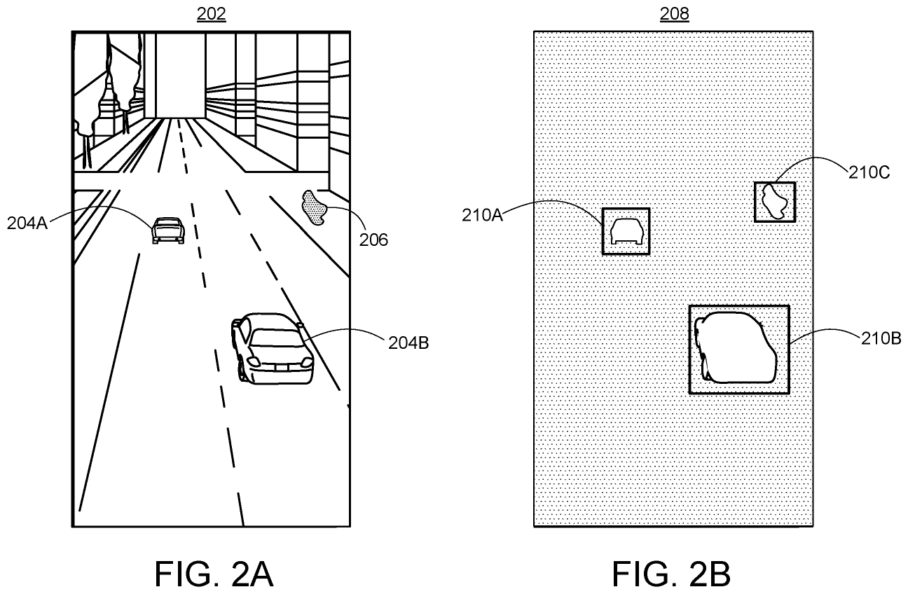

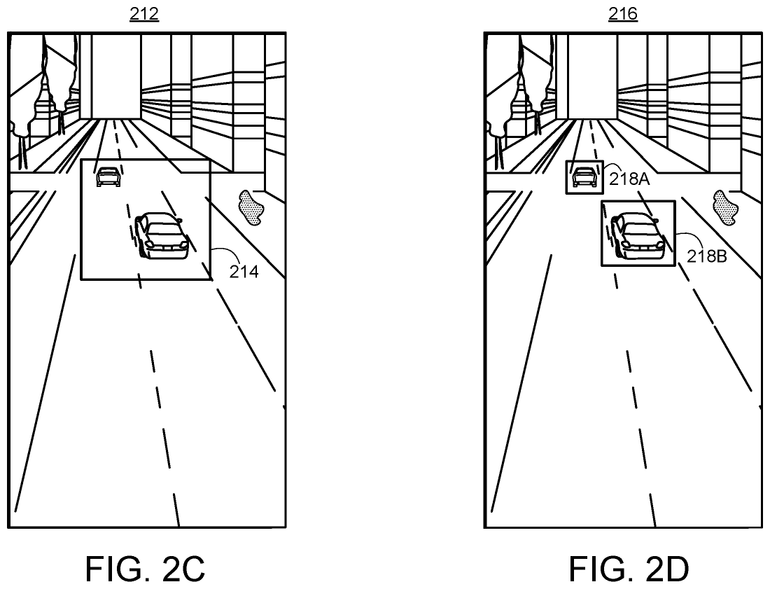

FIGS. 2A-2D depict an example scenario of processing video stream data according to the pipeline depicted in FIG. 1. In FIG. 2A, a frame data 202 is depicted as resulting from processing of a live video stream by decoding module 110. Frame data 202 depicts a roadway having a number of objects within the field of vision, such as vehicles 204A and 204B, and an oil spill 206. The query involved seeks to identify moving vehicles in the field of view, with a threshold confidence value of 75%.

As a result of processing by the decoding module 110, frame data 202 can be provided to background subtraction module 112 for processing, which can result in background subtraction frame 208 depicted in FIG. 2B. As shown, background subtraction module 112 detected various changes in the frame, depicted as 210A, 210B, and 210C. However, the results from background subtraction module 112 may not meet the threshold confidence value of 75%, and indeed, the background subtraction erroneously determined that oil spill 206 was a change in frames of the video stream, and subsequently marked this as change 210C, potentially as a result of light reflections being interpreted as movement. However, because the results from background subtraction module 112 do not meet the threshold confidence value, the frame data can be provided to edge processing module 114 for additional processing to seek the threshold confidence value.

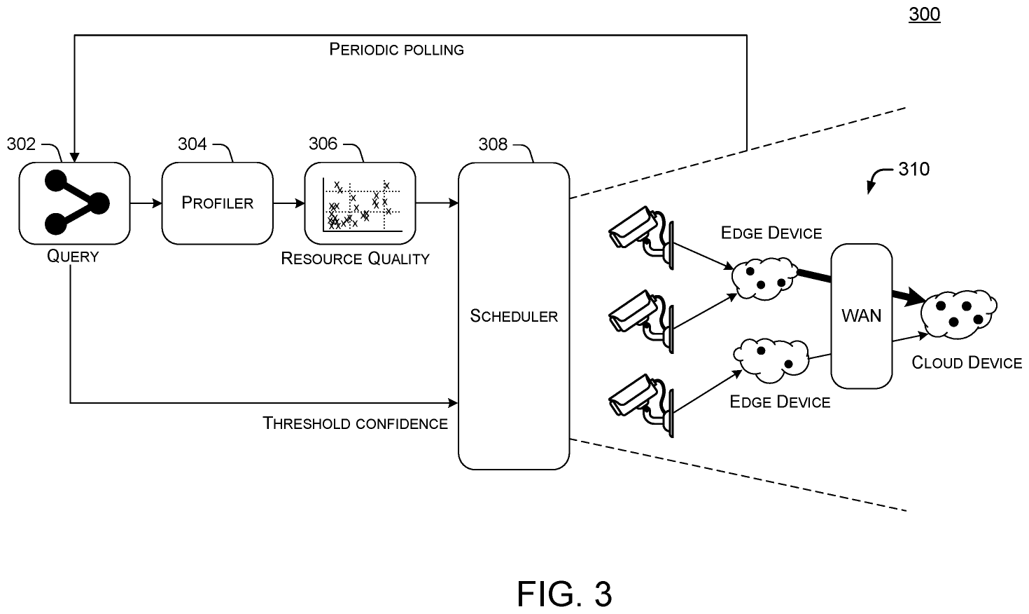

Edge processing module 114 may invoke, for example, a lightweight DNN model on the frame data, resulting in processed frame 212 depicted in FIG. 2C. As shown in processed frame 212, the lightweight DNN model correctly excluded oil spill 206, but had difficulty in determining that there are two vehicles moving, as the lightweight DNN model grouped both cars into a detected change 214. Yet again, however, the lightweight processing module may not meet the 75% threshold confidence value for a number of reasons discussed in further detail with regard to FIG. 3, such as where the frame data resolution was too low due to a selected processing configuration. As a result, the pipeline may turn to cloud processing by invoking cloud processing module 116.

Cloud processing module 116 may invoke, for example, a heavy DNN model on the frame data, resulting in processed frame 216 depicted in FIG. 2D. As shown in processed frame 216, the heavy DNN model correctly excluded oil spill 206, and also was able to determine the existence of two moving vehicles 218A and 218B in the frame with a high level of confidence. As such, the pipeline can allocate processing between the local edge devices, such as by performing local processing 118, and can invoke cloud processing when the local processing results are not of satisfactory confidence based on the defined threshold confidence value.

FIG. 3 depicts an example process 300 depicting the use of a pipeline optimizer that can be used to determine an initial appropriate allocation of resources throughout the system. As depicted in FIG. 3, a query 302 can be received, such as a query to detect the presence of a vehicle in a particular area of a video stream. Query 302 may include a threshold confidence value, which can be pre-set or dynamically provided by a user of the system, such as a user who issues the query.

Upon receiving the query, profiler 304 can perform resource accuracy profiling, which can estimate the total resource requirements of the query and can take into account the threshold confidence value. Specifically, profiler 304 may select from a plurality of different resource configurations that are to be utilized for the video analytics. These configurations can represent adjustable attributes or settings that are applied to the analytical pipeline, which can impact query accuracy and resource demands. The configurations can be multi-dimensional and can include choices such as frame resolution, frame rate, and what DNN model to use (i.e., either the lightweight model or heavy model, or in some instances, both models). While configurations such as higher resolution or higher frame rate can improve detection, these configurations can also overburden available resources or bandwidth capabilities.

The configuration choice can have a considerable impact on the resource usage of the video pipeline as well as the accuracy of the output produced. For example, a configuration that processes videos at low frame rates by sampling off frames and using DNNs with many convolutional layers stripped out drastically reduces the computational requirements, but this can significantly lower accuracy in the detected objects. Alternatively, a configuration that sends a minor amount of processing to cloud device 106 (rather than keeping all processing local) may receive a much higher accuracy, at the added expense of additional bandwidth usage. As such, multiple different configurations can be determined, where each configuration can have an associated accuracy and an associated cost.

To determine the appropriate configuration, profiler 304 can access a database of video processing configurations, which can then be evaluated against resource available between the edge devices and the cloud devices to result in a resource quality dataset 306, depicted in FIG. 3 in a graph form. Resource quality dataset 306 can be developed by, for example, recording a small amount of video at the given configuration. The recorded video can then be tested against the resource capabilities of the devices using the various data processing models, such as lightweight models and heavy models, to determine appropriate processing times and resource consumption. Based on this testing, a number of data plots can be established that define a certain accuracy level based on the configuration, such as frame resolution, frame rate, bandwidth rate, and/or processing cores available to a given device. Furthermore, the testing can be repeated based on changing conditions, such as network availability or bandwidth, to ensure that a new query can be handled in the most efficient manner.

Therefore, profiler 304 can attempt to achieve an optimal tradeoff and maximize the average accuracy of outputs based on this testing data by picking a configuration that achieves an optimal use of resources given a current state of the pipeline, such as network availability, processing core availability, and CPU/GPU availability. Specifically, profiler 304 can determine that for each pipeline p with a given configuration cₚ, an accuracy for that pipeline aₚ can be calculated. Then, for all of the pipelines that are being used, profiler 304 can evaluate the accuracies to achieve an average maximized accuracy according to:

$$( \frac{1}{N} {\sum }_{p = 1}^{N} {a}_{p} ) \to max$$

where N is the number of cameras that are being used associated with the pipelines.

Upon determining the appropriate configuration to be used, scheduler 308 can allocate processing between the various devices 310, taking into account the threshold confidence value associated with the query. Furthermore, scheduler 308 may instruct the various edge devices to perform processing, but if changing system conditions could potentially result in a loss of confidence in results (i.e., less computational resources than were expected at the edge devices, due to a failure in a particular edge device), scheduler 308 may adjust the configuration to include additional processing at one or more cloud devices.

Furthermore, the system may perform periodic polling of resource availability between the edge and cloud devices. While the initial configuration may attempt to achieve a maximized accuracy, changing system and network conditions can affect the ability to achieve this efficient processing. Therefore, a periodic polling loop may operate, whereby the various conditions associated with the devices are checked, and when resource availability has changed, the allocation of processing between the edge and cloud devices can be modified to reflect the change in resources.

For example, while profiler 304 may have selected a configuration that includes heavy DNN model processing on the cloud, the current bandwidth between the edge devices and the cloud may be limited due to an increase in traffic, or the WAN connection could be offline and unavailable. In this instance, profiler 304 may adjust processing to achieve an “edge-only” mode by allocating all of the processing to edge device 104, and may specify that edge device 104 should use more aggressive computational models than would normally be executed on the device, such as by using a moderate computationally-intensive processing model rather than a lightweight processing model. Additionally, profiler 304 may allocate processing responsibility to smart cameras 102 using a lightweight computational model, depending on the processing capabilities of the smart cameras, while the aggressive computational model is run on edge device 104. In some instances, profiler 304 may also dynamically lower the threshold confidence value to enable results to be used from the edge devices. Then, once the periodic polling reports that the network capability to the cloud has been restored, profiler 304 may dynamically shift the processing load back to the original distribution based on the selected configuration.

In certain instances, it may be known in advance what scene the smart cameras are recording, as a specific cluster of cameras and edge devices may be associated with an environment that is known to have a high density of objects. For example, a cluster of cameras and edge devices may be placed at a central intersection in a city, where it is known that the video stream tends to have a high density of moving objects at any point in time. Due of the high density of the video stream, profiler 304 may be configured to weight toward greater reliance and allocation of tasks to heavy computational model processing, as performing simple background subtraction on the high-density video stream will typically result in a low confidence value associated with the processing. Thus, profiler 304 may allocate resources based on the specific video feed, in addition to or in place of the selected configuration. That is, because profiler 304 may have a priori knowledge that certain video cameras are in high density areas, profiler 304 may allocate tasks with a weight toward heavy computational model processing, as profiler 304 knows that any lightweight model will be incapable of achieving a threshold confidence value.

Furthermore, profile 304 may dynamically modify resource allocation depending on changing circumstances in an environment. For example, a camera that may face a central atrium of a building may have a far greater amount of traffic than a camera that is located in a remote conference room of the office. Therefore, depending on which video stream is being analyzed, profiler 304 may select a particular configuration that utilizes heavy processing with respect to the central atrium camera's video stream, but may select a configuration that relies solely on background subtraction with respect to the conference room camera.

Profiler 304 may then dynamically change the selected configuration based on detected movement in the conference room. For example, if a meeting is to occur in the conference room, it can be assumed that the density of objects in the video stream will increase, and profiler 304 may dynamically change the selected configuration for the video analytics to rely on heavier model processing, since background subtraction processing would likely be insufficient to achieve the threshold confidence value due to the increase density of objects in the video stream.

In another instance, latency requirements for a particular query can be taken into consideration when profiler 304 attempts to determine the necessary allocation of resources. For example, if an application needs a detection result within 30 milliseconds of the live video being received, this time constraint may be difficult or impossible to achieve based on available bandwidth. As such, profiler 304 may determine that processing at the cloud is not feasible, and may therefore assign an aggressive level of processing on the edge devices. Furthermore, depending on priorities, the latency requirements may override the threshold confidence value, such that the processed data received from the edge devices is used as a detection result, even if the processed data does not have a result that meets the threshold confidence value. In this manner, certain processing parameters may overrule other parameters.

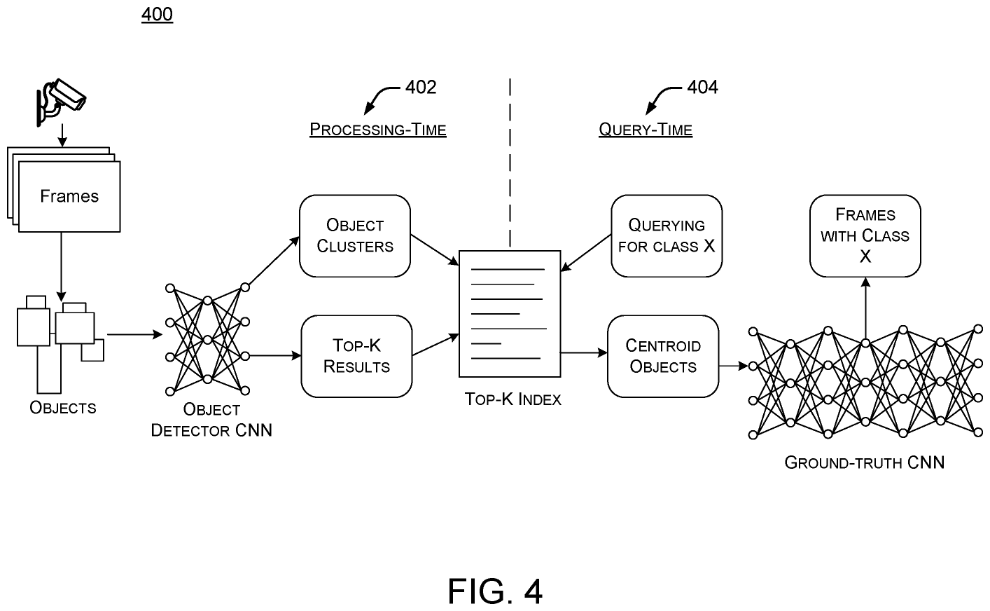

FIG. 4 depicts a process 400 in which the results of the live video analytics can be used as an index for after-the-fact interactive querying on stored version of the live video stream. Process 400 can be divided into two time periods, a processing-time 402 and a query-time 404. Specifically, during processing-time 402 of video frames as part of the video analytics pipeline referenced in FIG. 1, tags can be assigned to objects discovered during processing of frame data, such as during processing of data by way of object detector convolutional network classifiers (CNNs) that can detect objects in a frame and classify the objects.

Objects can be clustered based on feature vectors into object clusters, and a top-K index can be created which maps each class to a set of object clusters. The top-K ingest index provides a mapping between object classes and the clusters. Then, at a query time, such as when a user queries for a certain class X, matching clusters can be retrieved from the top-K index, and the centroids of the clusters are run through a ground truth CNN model to filter out potential frames that do not contain object class X.

For example, if a red car is detected in the video frame, an index tag of “red car” can be associated with that particular video frame and stored for later access. As such, the system is capable of responding to a query such as “find frames with a red car in the last week” by accessed the stored index tag data and finding all index tags of “red car.” Moreover, because the video frames have been processed in the past as part of the video analytics pipeline, fulfilling this request to find all red cars in the last week does not require processing a week's worth of video data, which saves computational time and resources.

### Example Video Analytics Method

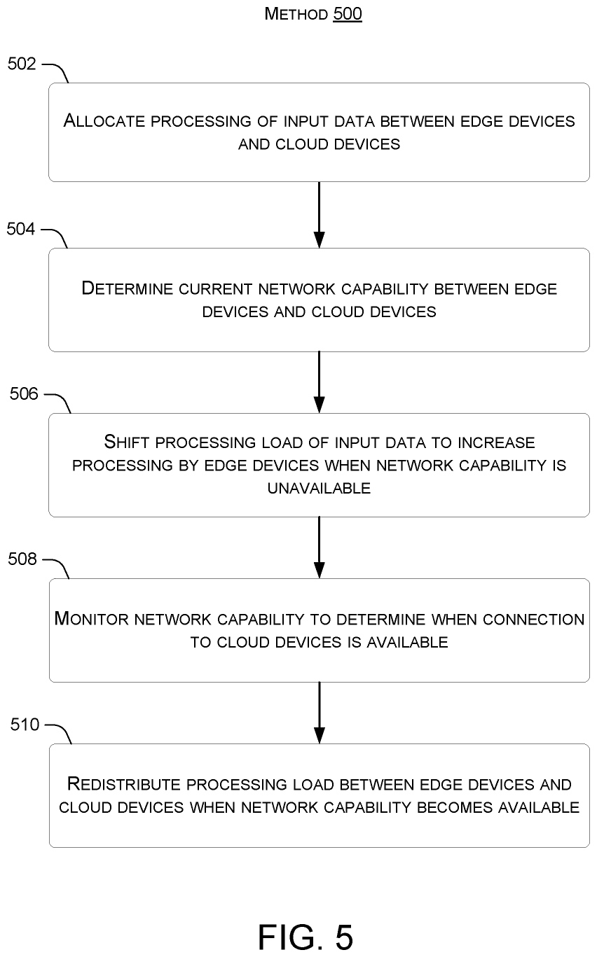

The following discussion presents an overview of functionality regarding the allocation of processing between edge devices and cloud devices according to one implementation. FIG. 5 illustrates an exemplary method 500, consistent with the present concepts. Method 500 can be implemented by a single device, e.g., edge device 104, or can be distributed over one or more devices. Moreover, method 500 can be performed by one or more modules, such as profiler 304.

At block 502, processing of input data can be allocated between one or more edge devices and one or more cloud devices. The allocation of processing can be determined, for example, according to the configuration selected by profiler 304, which can specify that lightweight model processing (i.e., a computationally-light processing algorithm) should be performed at edge devices, while heavy model processing (i.e., a computationally-heavy processing algorithm) should be performed at cloud devices.

At block 504, the system may determine the current network capabilities between the edge devices and the cloud devices. For example, profiler 304 may evaluate the current network bandwidth capacity or availability based on periodic polling of the status of the network.

At block 506, the system may shift the processing load of input data based on the determined network capabilities. For example, profiler 304 may determine that the current network connection to the cloud devices is unavailable, and as such, may shift processing load to increase processing by the edge devices using a more aggressive computational model. That is, while the edge devices may have been performing lightweight model processing, due to the change in network conditions and the unavailability of cloud devices, profiler 304 may specify that the edge devices should use a moderate computationally-intensive model in order to increase the confidence of results received from the edge devices. Furthermore, profiler 304 may then assign background subtraction processing, or the lightweight model processing, to the smart cameras to provide additional processing support to the edge devices.

At block 508, profiler 304 may monitor the network capability between the edge devices and the cloud devices according to the periodic polling in order to determine when connection to the cloud devices is available.

Finally, at block 510, profiler can redistribute the processing load between the edge devices and the cloud devices according to the selected configuration, once the periodic polling indicates that the network capability to the cloud devices has returned.

### Device Implementations

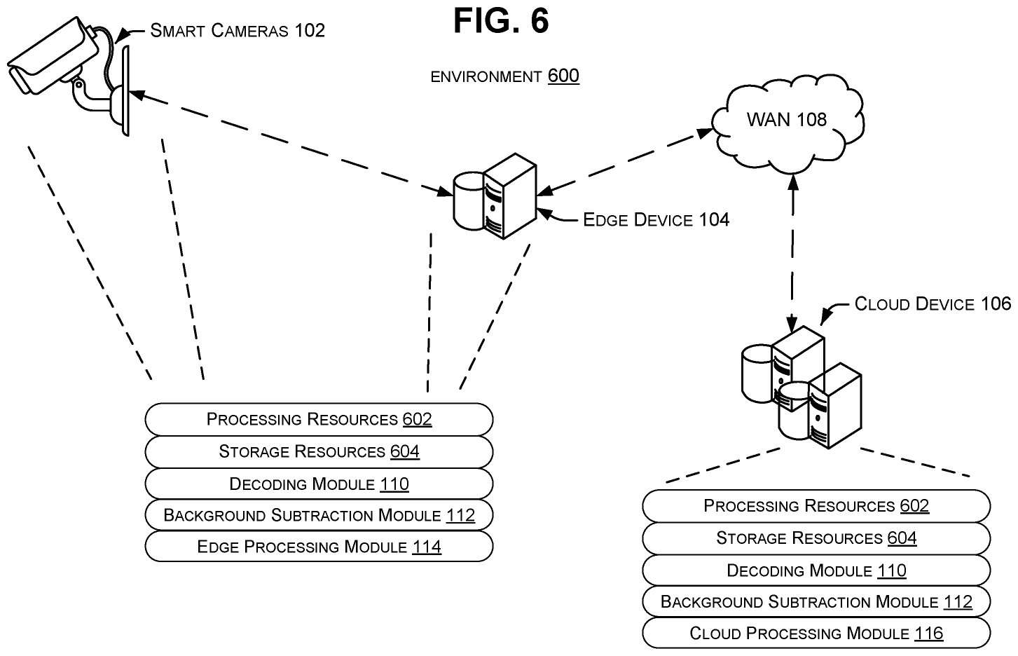

The present implementations can be performed in various scenarios on various devices. FIG. 6 shows an example environment 600 in which the present implementations can be employed, as discussed more below.

As shown in FIG. 6, environment 600 can include one or more smart cameras 102, an edge device 104, and a cloud device 106 connected by WAN 108. Note that the edge device can be embodied as a server as depicted in FIG. 6, but may also be any sort of computer that has sufficient processing capability to perform video analytics, and in some instances, may include portable devices with dedicated GPUs. Likewise, the cloud device 106 can be implemented using various types of computing devices.

Generally, the devices 102, 104, and 106 each may have respective processing resources 602 and storage resources 604, which are discussed in more detail below. The devices may also have various modules that function using the processing and storage resources to perform the techniques discussed herein, as discussed more below. The storage resources can include both persistent storage resources, such as magnetic or solid-state drives, and volatile storage, such as one or more random-access memory devices. In some cases, the modules are provided as executable instructions that are stored on persistent storage devices, loaded into the random-access memory devices, and read from the random-access memory by the processing resources for execution.

Generally, any of the devices shown in FIG. 6 can include the various modules discussed with reference to FIG. 1. Specifically, due to the ability of the system to dynamically allocate processing between any of the devices, each of the devices may include a decoding module 110 and a background subtraction module 112. Furthermore, smart camera 102 and edge device 104 may include an edge processing module 114, while cloud device 106 may include a cloud processing module 116. The functionality of these modules is discussed above with reference to FIG. 1.

While FIG. 6 depicts only certain devices, it is to be appreciated that several alternative devices could be used in place of, or in addition to devices 102, 104, and 106. Specifically, as long as a device has some computational hardware, the device can be used to perform video analytics according to the implementations set forth above. Of course, not all device implementations can be illustrated and other device implementations should be apparent to the skilled artisan from the description above and below.

The term “device”, “computer,” “computing device,” “edge device,” and or “cloud device” as used herein can mean any type of device that has some amount of hardware processing capability and/or hardware storage/memory capability. Processing capability can be provided by one or more hardware processors (e.g., hardware processing units/cores) that can execute data in the form of computer-readable instructions to provide functionality. Computer-readable instructions and/or data can be stored on storage, such as storage/memory and or the datastore.

Storage resources 604 can be internal or external to the respective devices with which they are associated. The storage resources 604 can include any one or more of volatile or non-volatile memory, hard drives, flash storage devices, and/or optical storage devices (e.g., CDs, DVDs, etc.), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and flash memory, among others.

In some cases, the devices are configured with processing resources 602, which may be a general-purpose hardware processor, and storage resources 604. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor,” “hardware processor” or “hardware processing unit” as used herein can also refer to central processing units (CPUs), graphical processing units (GPUs), controllers, microcontrollers, processor cores, or other types of processing devices suitable for implementation both in conventional computing architectures as well as SOC designs.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, any of the modules/code discussed herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

Also note that devices generally can have input and/or output functionality. For example, computing devices can have various input mechanisms such as keyboards, mice, touchpads, voice recognition, gesture recognition (e.g., using depth cameras such as stereoscopic or time-of-flight camera systems, infrared camera systems, RGB camera systems or using accelerometers/gyroscopes, facial recognition, etc.). Devices can also have various output mechanisms such as printers, monitors, etc.

Also note that the devices described herein can function in a stand-alone or cooperative manner to implement the described techniques. For example, the methods described herein can be performed on a single computing device and/or distributed across multiple computing devices that communicate over WAN 108. Without limitation, WAN 108 can include one or more local area networks (LANs), the Internet, and the like.

### Additional Examples

Various device examples are described above. Additional examples are described below. One example includes a system comprising a processor and a storage memory storing computer-readable instructions, which when executed by the processor, cause the processor to: receive a video query regarding a live video stream, determine resources available to the system and a defined threshold confidence value associated with the video query, select a configuration for processing the video query based at least on the determined resources, allocate processing between one or more cameras and one or more edge devices according to the selected configuration, and adjust the selected configuration to include processing among one or more cloud devices when processing results from the one or more cameras and the one or more edge devices do not meet the defined threshold confidence value.

Another example can include any of the above and/or below examples where the selected configuration directs the one or more cameras or the one or more edge devices to extract video frames from the live video stream using a decoding module.

Another example can include any of the above and/or below examples where the selected configuration directs the one or more cameras or the one or more edge devices to perform background subtraction on the extracted video frames.

Another example can include any of the above and/or below examples where the background subtraction is performed on the extracted video frames to determine whether additional processing should be performed.

Another example can include any of the above and/or below examples where the selected configuration directs the one or more cameras or the one or more edge devices to perform processing of the extracted video frames using a lightweight DNN model locally on the one or more cameras or the one or more edge devices.

Another example can include any of the above and/or below examples where the selected configuration directs the one or more cloud devices to perform processing of the extracted video frames using a heavy DNN model when results from the lightweight DNN model do not meet the defined threshold confidence value.

Another example can include any of the above and/or below examples where the lightweight DNN model comprises at least a first lightweight DNN model, and a second lightweight DNN model that requires additional computational resources than the first lightweight DNN model, but less computational resources than the heavy DNN model.

Another example can include any of the above and/or below examples where the heavy DNN model comprises at least a first heavy DNN model, and a second heavy DNN model that requires additional computational resources than the first heavy DNN model.

Another example can include any of the above and/or below examples where the computer-readable instructions, when executed by the processor, further cause the processor to assign tags to objects discovered during processing of the extracted video frames and store the tags in an index database for use in locating the objects in response to a query on a stored version of the live video stream.

Another example can include any of the above and/or below examples where the computer-readable instructions, when executed by the processor, further cause the processor to dynamically determine whether resources available to the system have changed and when the resource availability has changed, modify the allocation of processing among the one or more cameras, the one or more edge devices, and the one or more cloud devices based at least on the resource availability having changed.

Another example can include any of the above and/or below examples where determining resources available to the system further comprises determining whether network connectivity to the one or more cloud devices is available.

Another example can include any of the above and/or below examples where the selected configuration is adjusted to an edge-only mode of processing by allocating all processing between the one or more cameras and the one or more edge devices when network connectivity to the one or more cloud devices is unavailable or bandwidth to the one or more cloud devices is insufficient.

Another example includes a method comprising allocating processing of input data between one or more edge devices and one or more cloud devices, the one or more edge devices using an edge processing model, and the one or more cloud devices using a cloud processing model different from the edge processing model, determining a current network capability between the one or more edge devices and one or more cloud devices, and shifting processing load of the input data to increase processing by the one or more edge devices using a moderate computationally-intensive algorithm upon determining that the current network capability between the one or more edge devices and the one or more cloud devices is unavailable.

Another example can include any of the above and/or below examples where the method further comprises allocating processing to one or more smart devices, the one or more smart devices performing processing that is computationally cheaper than the edge processing model used by the one or more edge devices.

Another example can include any of the above and/or below examples where the method further comprises dynamically shifting the processing load of the input data back to the one or more cloud devices upon determining that the current network capability between the one or more edge devices and the one or more cloud devices has been restored.

Another example can include any of the above and/or below examples where the cloud processing model is a more computationally expensive model than the edge processing model.

Another example includes a method comprising receiving input video data from one or more cameras, accessing a database of a plurality of video processing configurations, evaluating the plurality of video processing configurations against resource availability across local devices and cloud devices, and selecting a configuration that allocates processing to the one or more cameras, one or more edge devices, and one or more cloud devices.

Another example can include any of the above and/or below examples where the video processing configurations specify a frame resolution, frame rate, and a type of DNN model to be used in processing the input video data.

Another example can include any of the above and/or below examples where the video processing configurations each have a resource cost, and a configuration is selected that achieves an optimal tradeoff between resource cost and average accuracy.

Another example can include any of the above and/or below examples where the method further comprises dynamically modifying the selected configuration upon determining that the resource availability has changed.

### Conclusion

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A system comprising:
a processor; and
a storage memory storing computer-readable instructions, which when executed by the processor, cause the processor to:
receive a video query regarding a live video stream;
determine resources available to the system and a defined threshold confidence value associated with the video query;
select a configuration for processing the video query based at least on the determined resources;
allocate processing between one or more cameras and one or more edge devices according to the selected configuration; and
adjust the selected configuration to include processing among one or more cloud devices when processing results from the one or more cameras and the one or more edge devices do not meet the defined threshold confidence value.

2. The system of claim 1, wherein the selected configuration directs the one or more cameras or the one or more edge devices to extract video frames from the live video stream using a decoding module.

3. The system of claim 2, wherein the selected configuration directs the one or more cameras or the one or more edge devices to perform background subtraction on the extracted video frames.

4. The system of claim 3, wherein the background subtraction is performed on the extracted video frames to determine whether additional processing should be performed.

5. The system of claim 3, wherein the selected configuration directs the one or more cameras or the one or more edge devices to perform processing of the extracted video frames using a lightweight DNN model locally on the one or more cameras or the one or more edge devices.

6. The system of claim 5, wherein the selected configuration directs the one or more cloud devices to perform processing of the extracted video frames using a heavy DNN model when results from the lightweight DNN model do not meet the defined threshold confidence value.

7. The system of claim 6, wherein the lightweight DNN model comprises at least a first lightweight DNN model, and a second lightweight DNN model that requires additional computational resources than the first lightweight DNN model, but less computational resources than the heavy DNN model.

8. The system of claim 7, wherein the heavy DNN model comprises at least a first heavy DNN model, and a second heavy DNN model that requires additional computational resources than the first heavy DNN model.

9. The system of claim 6, wherein the computer-readable instructions, when executed by the processor, further cause the processor to:
assign tags to objects discovered during processing of the extracted video frames; and
store the tags in an index database for use in locating the objects in response to a query on a stored version of the live video stream.

10. The system of claim 1, wherein the computer-readable instructions, when executed by the processor, further cause the processor to:
dynamically determine whether resources available to the system have changed; and
when the resource availability has changed, modify the allocation of processing among the one or more cameras, the one or more edge devices, and the one or more cloud devices based at least on the resource availability having changed.

11. The system of claim 1, wherein determining resources available to the system further comprises determining whether network connectivity to the one or more cloud devices is available.

12. The system of claim 1, wherein the selected configuration is adjusted to an edge-only mode of processing by allocating all processing between the one or more cameras and the one or more edge devices when network connectivity to the one or more cloud devices is unavailable or bandwidth to the one or more cloud devices is insufficient.

13. A method comprising:
allocating processing of input data between one or more edge devices and one or more cloud devices, the one or more edge devices using an edge processing model, and the one or more cloud devices using a cloud processing model different from the edge processing model;
determining a current network capability between the one or more edge devices and one or more cloud devices; and
shifting processing load of the input data to increase processing by the one or more edge devices using a moderate computationally-intensive algorithm upon determining that the current network capability between the one or more edge devices and the one or more cloud devices is unavailable.

14. The method of claim 13, further comprising allocating processing to one or more smart devices, the one or more smart devices performing processing that is computationally cheaper than the edge processing model used by the one or more edge devices.

15. The method of claim 13, further comprising dynamically shifting the processing load of the input data back to the one or more cloud devices upon determining that the current network capability between the one or more edge devices and the one or more cloud devices has been restored.

16. The method of claim 13, wherein the cloud processing model is a more computationally expensive model than the edge processing model.

17. A method comprising:
receiving input video data from one or more cameras;
accessing a database of a plurality of video processing configurations;
evaluating the plurality of video processing configurations against resource availability across local devices and cloud devices; and
selecting a configuration that allocates processing to the one or more cameras, one or more edge devices, and one or more cloud devices.

18. The method of claim 17, wherein the video processing configurations specify a frame resolution, frame rate, and a type of DNN model to be used in processing the input video data.

19. The method of claim 17, wherein the video processing configurations each have a resource cost, and a configuration is selected that achieves an optimal tradeoff between resource cost and average accuracy.

20. The method of claim 17, further comprising dynamically modifying the selected configuration upon determining that the resource availability has changed.
